(19) United States
(12) Patent Application Publication
(10) Pub. No.: US 2026/0062086 A1
(43) Pub. Date: Mar. 5, 2026

(54) Tandem Bicycle Device

(71) Applicant: Robert Earl Means, JR., Sedalia, KY (US)

(72) Inventor: Robert Earl Means, JR., Sedalia, KY (US)

(21) Appl. No.: 19/266,260

(22) Filed: Jul. 11, 2025

Related U.S. Application Data
(60) Provisional application No. 63/687,323, filed on Aug. 27, 2024.

(51) Int. Cl. B62K 3/12; B62K 21/12; B62K 21/16

(52) U.S. Cl. CPC B62K 3/12; B62K 21/125; B62K 21/16

(57) ABSTRACT

A tandem bicycle device is provided. The device is comprised of a tandem bicycle device configured to minimize longitudinal separation between riders through a compact frame geometry incorporating a first seat and a second seat positioned in close proximity, as well as a closely spaced front crankset and rear crankset. The device has a second handlebar set connected to the frame via a pivot point allowing forward rotation of the handlebar set for active use by a second rider or retraction when not in use. The pedal system comprises two cranksets interconnected by a synchronization mechanism such as a dual-chain or timing belt system to ensure coordinated pedaling. The overall configuration reduces torsional frame flex and aerodynamic drag while improving shared rider control and engagement.

### CROSS REFERENCE TO RELATED APPLICATION

The present application claims priority to, and the benefit of, U.S. Provisional Application No. 63/687,323, which was filed on Aug. 27, 2024, and is incorporated herein by reference in its entirety.

### FIELD OF THE INVENTION

The present invention relates generally to the field of tandem bicycles. More specifically, the present invention relates to a tandem bicycle comprising a compact frame geometry with closely positioned seats and cranksets to reduce longitudinal separation between riders, enhance aerodynamic efficiency, and minimize torsional frame flex. The device also includes a second handlebar set mounted on a pivot point for adjustable use by a second rider and a synchronized pedal system with interconnected cranksets for coordinated pedaling and improved shared control. Accordingly, the present disclosure makes specific reference thereto. Nonetheless, it is to be appreciated that aspects of the present invention are also equally applicable to other like applications, devices, and methods of manufacture.

### BACKGROUND

Tandem bicycles, which allow two riders to operate a single bicycle simultaneously, present significant coordination and control challenges, especially for novice users. The increased frame length, extended rider separation, and dual-input dynamics introduce balancing difficulties that differ substantially from single-rider bicycles. These factors often lead to longer learning curves and reduced confidence among new tandem riders. Standard tandem configurations typically place the cyclists at a considerable distance apart, which can complicate communication and make it more difficult to synchronize pedaling and steering. Additionally, the rear cyclist may feel disengaged from the steering process, as they lack access to effective control mechanisms. This lack of synchronization can lead to inefficient power transfer, frame torsion, and reduced stability. These drawbacks limit the accessibility of tandem bicycles for casual use, instructional scenarios, or competitive training.

Therefore, there exists a long-felt need in the art for a tandem bicycle device that enables improved rider balance through reduced longitudinal separation. There also exists a long-felt need in the art for a tandem bicycle device that provides ergonomic and practical handlebar access for the rear cyclist. Moreover, there exists a long-felt need in the art for a tandem bicycle device that facilitates enhanced synchronization and communication between cyclists during operation.

The subject matter disclosed and claimed herein, in one embodiment thereof, comprises a tandem bicycle device. The device is comprised of a tandem bicycle device configured to minimize longitudinal separation between riders through a compact frame geometry incorporating a first seat and a second seat positioned in close proximity, as well as a closely spaced front crankset and rear crankset. The device has a second handlebar set connected to the frame via a pivot point allowing forward rotation of the handlebar set for active use by a second rider or retraction when not in use. The pedal system comprises two cranksets interconnected by a synchronization mechanism such as a dual-chain or timing belt system to ensure coordinated pedaling. The overall configuration reduces torsional frame flex and aerodynamic drag while improving shared rider control and engagement.

In this manner, the tandem bicycle device of the present invention accomplishes all the forgoing objectives and provides a compact tandem bicycle configuration that enhances balance and reduces the learning curve associated with tandem operation. The device further addresses the need for improved rear rider control by introducing a rotatable and lockable handlebar assembly, thereby increasing both ergonomic comfort and functional engagement. The closely spaced cranksets and synchronized pedal system further promote efficient power transfer and coordinated movement, facilitating better communication and stability during riding. As a result, the tandem bicycle device provides a practical and effective solution to the coordination and balance challenges inherent in traditional tandem bicycle systems.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tandem bicycle device. The device is a tandem bicycle configured with reduced longitudinal rider separation by minimizing the spacing between the first and second seats, as well as between the front and rear cranksets. This compact arrangement enhances rider motion synchronization, balance dynamics, power output efficiency, and aerodynamic performance during cooperative riding.

The device is comprised of a bicycle frame that includes a first seat for the front cyclist and a second seat positioned longitudinally behind it for the rear cyclist. A second handlebar set is positioned for the rear cyclist and mounted to the frame via a pivot point near the rear of the first seat. The pivot point allows the handlebar set to rotate between a forward position for riding and a rear retracted position when not in use. The handlebar set may be locked in either position using a locking mechanism such as a detent pin or cam lock. The pedal system is comprised of a front crankset and a rear crankset interconnected by a synchronization mechanism. Each crankset includes at least one pedal.

A method of using the device involves positioning two cyclists on the respective seats, grasping the appropriate handlebars, rotating and securing the rear handlebar set as needed, initiating coordinated pedaling through the synchronization mechanism, actuating brakes as necessary, and retracting the rear handlebar set when only one cyclist is present.

Accordingly, the tandem bicycle device of the present invention is particularly advantageous as it provides a compact tandem bicycle configuration that enhances balance and reduces the learning curve associated with tandem operation. The device further addresses the need for improved rear rider control by introducing a rotatable and lockable handlebar assembly, thereby increasing both ergonomic comfort and functional engagement. The closely spaced cranksets and synchronized pedal system further promote efficient power transfer and coordinated movement, facilitating better communication and stability during riding. As a result, the tandem bicycle device provides a practical and effective solution to the coordination and balance challenges inherent in traditional tandem bicycle systems and overcomes the limitations of existing tandem bicycles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a tandem bicycle device of the present invention with the second set of handlebars in a forward position in accordance with the disclosed architecture;

FIG. 2 illustrates a side view of one potential embodiment of a tandem bicycle device of the present invention with the second set of handlebars in a rear position in accordance with the disclosed architecture; and

FIG. 3 illustrates a flowchart of a method of using one potential embodiment of a tandem bicycle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a tandem bicycle device that enables improved rider balance through reduced longitudinal separation. There also exists a long-felt need in the art for a tandem bicycle device that provides ergonomic and practical handlebar access for the rear cyclist. Moreover, there exists a long-felt need in the art for a tandem bicycle device that facilitates enhanced synchronization and communication between cyclists during operation.

The present invention, in one exemplary embodiment, is comprised of a tandem bicycle device. The device features a reduced longitudinal separation between riders, achieved by minimizing the spacing between the first and second seats and the corresponding front and rear cranksets. This compact design improves synchronization of rider motion, enhances balance dynamics, increases pedaling efficiency, and reduces aerodynamic drag during cooperative cycling. The device may also be integrated into an electric bike.

The device comprises a bicycle frame that integrates a first seat for the front cyclist and a second seat positioned behind the first. A second handlebar set is mounted to the frame near the rear of the first seat via a pivot point, which permits rotation between a forward riding position and a retracted rear position. The handlebar set may be secured in either position using a locking mechanism such as a detent pin or cam lock. The pedal system includes front and rear cranksets, which are linked by a synchronization mechanism. Each crankset is equipped with at least one pedal.

A method of operation includes seating the cyclists in their respective positions, grasping the appropriate handlebars, adjusting and securing the rear handlebar set as needed, initiating synchronized pedaling via the synchronization mechanism, engaging the braking system as required, and retracting the rear handlebar set when the bicycle is operated by a single rider.

As a result, the device offers a compact structure that improves balance and simplifies tandem riding. Enhanced rear rider control is achieved through the inclusion of a rotatable, lockable handlebar assembly, increasing ergonomic comfort and usability. The closely positioned cranksets and synchronized pedal system support efficient power transfer and coordinated motion, improving communication and ride stability. As such, the device effectively addresses coordination and balance challenges associated with conventional tandem bicycles and offers improvements over existing designs.

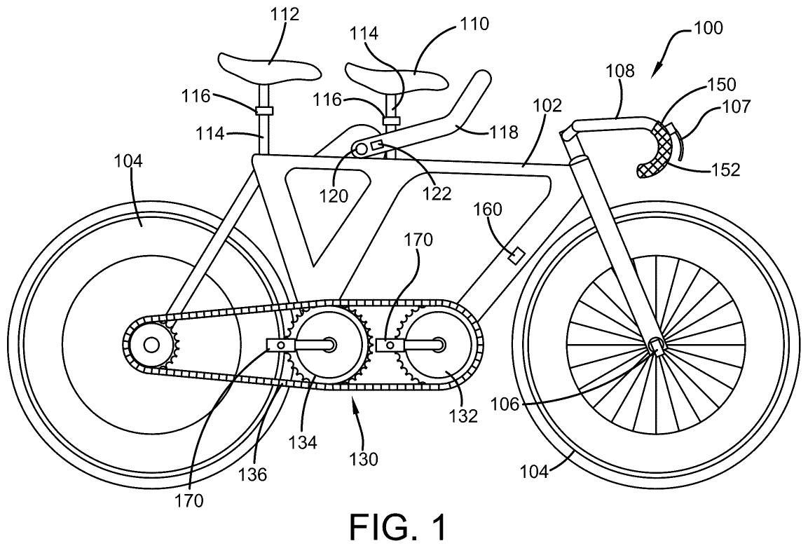

Referring initially to the drawings, FIG. 1 illustrates a side view of one potential embodiment of a tandem bicycle device 100 of the present invention with the second set of handlebars 118 in a forward position in accordance with the disclosed architecture. The device 100 is a tandem bicycle configured with reduced longitudinal rider separation by minimizing the spacing between the first seat 110 and the second seat 112, as well as between the corresponding front crankset 132 and rear crankset 134. This compact configuration may allow for enhanced synchronization of rider motion, improved balance dynamics, and more efficient shared power output during pedaling by reducing torsional flex along the frame 102 and facilitating closer rider communication. The reduced separation may also contribute to a lower aerodynamic drag profile, particularly during cooperative high-speed riding scenarios.

The device 100 is comprised of a frame 102. The frame 102 may be any style of bicycle frame such as but not limited to a diamond frame, step-through frame, recumbent frame, longtail frame, Y-frame, monotube frame, or semi-recumbent tandem configuration. The geometry of the frame 102 may be customized to accommodate riders of varying heights while preserving a minimal inter-rider spacing. The frame 102 may be constructed from structural materials such as but not limited to 6061 or 7005 aluminum alloys, unidirectional or woven carbon fiber composites with epoxy resin matrices, chromoly steel alloys, titanium alloys, or hybrid combinations thereof. These materials may offer high tensile strength-to-weight ratios, corrosion resistance, and fatigue resistance under dual-rider dynamic loading conditions.

The frame 102 may be equipped with at least one reflector 160 mounted to enhance visibility during low-light conditions. The reflector 160 may be located anywhere on the device 100. The reflector 160 may be comprised of materials such as but not limited to prismatic acrylic substrates, high-reflectivity retroreflective polymers, microprism film overlays, or metal-backed reflector lenses with colored tinting.

The device 100 may also be comprised of at least one wheel 104, a braking system 106, and a first handlebar set 108 for a front cyclist. Each wheel 104 may be selected from standard bicycle wheel configurations such as but not limited to 26-inch, 27.5-inch, 700 c, or 29-inch diameters. The wheel 104 may be laced spoke wheels, molded mag wheels, monocoque carbon fiber wheels, high-tension composite-laced wheels, etc.

The braking system 106 may be comprised of but is not limited to mechanical or hydraulic disc brakes, rim caliper brakes, drum brakes, or coaster brakes, and is preferably actuated via controls 107 integrated into the handlebar sets 108,118. The control 107 may include but is not limited to hand levers, dual-control brake-shift units, servo-actuated brake pods, or wireless electronic actuation modules.

The handlebar set 108 may be selected from configurations such as but not limited to drop bars, flat bars, riser bars, butterfly bars, bullhorn bars, swept-back touring bars, triathlon-style aero bars, etc. Handlebar 108 geometries may differ in different embodiments to support upright or aerodynamic riding postures depending on frame design and intended usage scenarios.

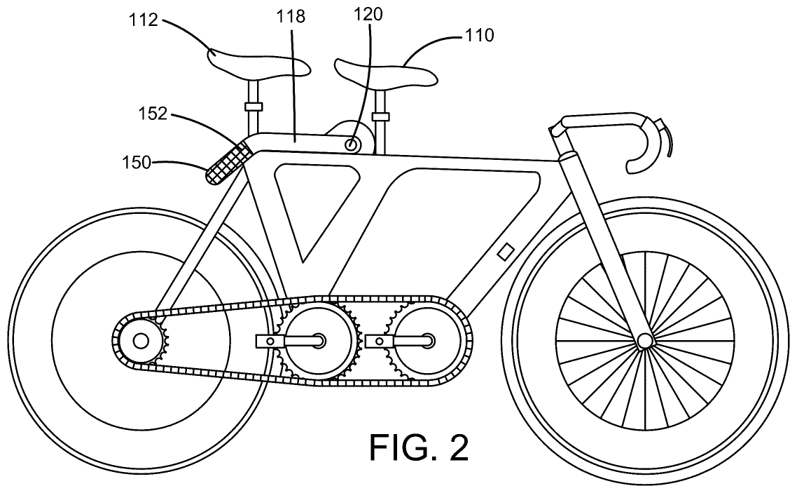

The frame 102 comprises a first seat 110 for a front cyclist and a second seat 112 for a rear cyclist, with the second seat 112 longitudinally positioned behind the first seat 110, as seen in FIG. 1 and FIG. 2. Each seat 110,112 may be any suitable type such as but not limited to standard touring saddles, racing saddles, suspension saddles, cruiser-style saddles, anatomical gel-padded saddles, modular saddles with adjustable nose sections, etc. Each seat 110,112 is secured to the frame 102 via at least one seat post 114. Each seat post 114 may be vertically adjustable and may be comprised of a locking mechanism 116 configured to maintain height and tilt settings of each seat 110,112 during operation. The locking mechanism 116 may include but is not limited to a quick-release lever, a cam-lock collar, a threaded collar clamp, a wedge-style internal expansion plug, or an indexed ratcheting engagement system. Optional integrated damping elements may also be incorporated within the post 114 to reduce vertical shock transmission during riding.

The device 100 is further comprised of a second handlebar set 118 positioned for use by the rear cyclist. The second handlebar set 118 may be connected to the frame 102 via a pivot point 120. The pivot point 120 may be located near the rear area of the first seat 110 and may include but is not limited to a clevis pin joint, a torsion spring-loaded hinge, a rotational bearing assembly, a ball detent coupling, or a lockable swing arm bracket. The pivot point 120 may allow the handlebar set 118 to rotate between a forward-position (as seen in FIG. 1), wherein the handlebars 118 are positioned around the hips and/or torso of the front cyclist for grasping by the rear cyclist, and a retracted rear position (as seen in FIG. 2), wherein the handlebars 118 are rotated rearward behind the first seat 110 out of the way of the first rider when only one rider is using the device 100. The pivot point 120 may be secured in either position by at least one locking mechanism 122 such as but not limited to a detent pin, a spring-loaded latch, a rotary cam lock, a lever-actuated clamp, or a threaded engagement knob.

Each handlebar set 108,118 may further be comprised of at least one grip area 150. The grip area 150 may be positioned anywhere on the handlebars 108,118 to support ergonomic handling by cyclists. Each grip area 150 may be comprised of materials such as but not limited to thermoplastic rubber, silicone foam, closed-cell EVA foam, cork composite, leather wrap, or polyurethane with vibration-damping inserts. Each grip area 150 may further be comprised of a texturing 152 that may include but is not limited to ribbed, knurled, contoured, or perforated patterns to enhance tactile control and reduce hand fatigue over extended rides.

The device 100 is further comprised of a pedal system 130. The pedal system 130 may be comprised of a front crankset 132 for the front cyclist and a rear crankset 134 for the rear cyclist. The front crankset 132 and rear crankset 134 may be interconnected via a synchronization mechanism 136. The synchronization mechanism 136 may include but is not limited to a dual-chain configuration, a continuous timing belt system, a splined shaft drive, a fully enclosed gear linkage mechanism, etc.

The pedal system 130 is further comprised of at least one pedal 170 for each crankset 132,134. Each pedal 170 may be selected from pedal types such as but not limited to platform pedals, clipless pedals compatible with SPD or LOOK systems, toe-clip pedals, hybrid dual-platform pedals, or power meter-integrated pedals with telemetry output.

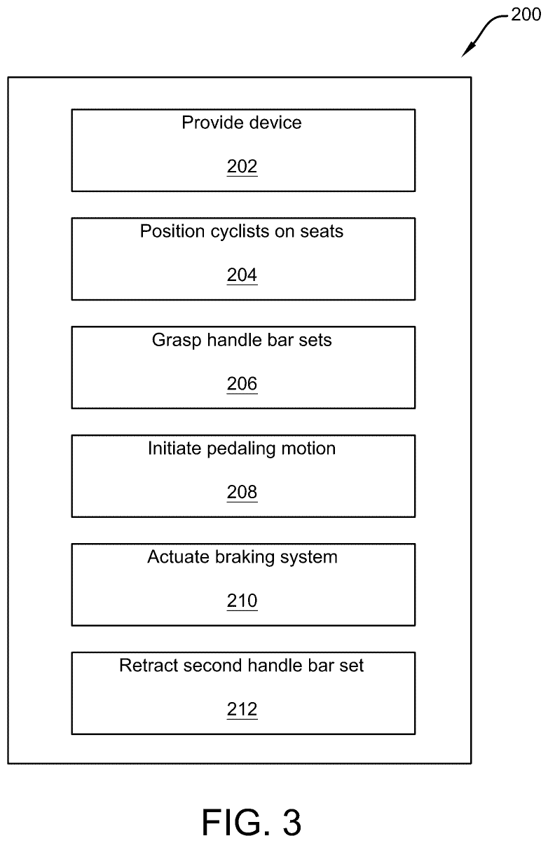

The present invention is also comprised of a method of using 200 the device 100, as seen in FIG. 3. First, a device 100 is provided comprised of a frame 102, a first seat 110, a second seat 112, at least one wheel 104, a braking system 106, a first handlebar set 108, a second handlebar set 118, a pedal system 130 comprised of a front crankset 132 and a rear crankset 134, and a synchronization mechanism 136 interconnecting the cranksets 132,134 [Step 202]. Then, a front cyclist may be positioned on the first seat 110 and a rear cyclist on the second seat 112 such that the cyclists are aligned with reduced longitudinal spacing for enhanced motion synchronization [Step 204]. Next, each cyclist may grasp the corresponding handlebar set 108,118 with hands placed on the grip areas 150 for ergonomic control, wherein the second handlebar set 118 may be rotated into a forward position around the front cyclist via the pivot point 120 and secured using the locking mechanism 122 [Step 206]. Each cyclist may then place their feet on the pedals 170, initiating a coordinated pedaling motion through the synchronization mechanism 136 to drive the interconnected cranksets 132,134 [Step 208]. Subsequently, each cyclist may actuate the braking system 106 via controls 107 mounted to the handlebar sets 108,118 to decelerate or stop the device 100 as required [Step 210]. Finally, the second handlebar set 118 may be rotated to a retracted rear position and secured using the locking mechanism 122 when only a single rider is operating the device 100 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tandem bicycle device” and “device” are interchangeable and refer to the tandem bicycle device 100 of the present invention.

Notwithstanding the forgoing, the tandem bicycle device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tandem bicycle device 100 as shown in the FIGS. are for illustrative purposes only, and that many other sizes and shapes of the tandem bicycle device 100 are well within the scope of the present disclosure. Although the dimensions of the tandem bicycle device 100 are important design parameters for user convenience, the tandem bicycle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tandem bicycle device comprising:
a frame;
a first seat attached to the frame;
a second seat attached to the frame and longitudinally positioned behind the first seat;
a first crankset;
a second crankset;
a synchronization mechanism interconnecting the first crankset and the second crankset;
a first handlebar set; and
a second handlebar set attached to the frame via a pivot point, the second handlebar set longitudinally positioned behind the first handlebar set.

2. The tandem bicycle device of claim 1 further comprised of a wheel.

3. The tandem bicycle device of claim 1 further comprised of a braking system.

4. The tandem bicycle device of claim 1 further comprised of a reflector.

5. The tandem bicycle device of claim 1, wherein the first handlebar set is comprised of a first grip area.

6. The tandem bicycle device of claim 5, wherein the first grip area is comprised of a first texture.

7. The tandem bicycle device of claim 1, wherein the first handlebar set is comprised of a second grip area.

8. The tandem bicycle device of claim 7, wherein the grip area is comprised of a second texture.

9. A tandem bicycle device comprising:
a frame;
a first seat attached to the frame;
a second seat attached to the frame and longitudinally positioned behind the first seat;
a first crankset;
a second crankset;
a synchronization mechanism interconnecting the first crankset and the second crankset;
a first handlebar set;
a second handlebar set attached to the frame via a pivot point, the second handlebar set longitudinally positioned behind the first handlebar set; and
wherein the pivot point is comprised of a locking mechanism.

10. The tandem bicycle device of claim 9, wherein the first crankset is comprised of a first pedal.

11. The tandem bicycle device of claim 9, wherein the second crankset is comprised of a second pedal.

12. The tandem bicycle device of claim 9 further comprised of a braking system.

13. The tandem bicycle device of claim 12, wherein the braking system is comprised of a disc brake, a rim caliper brake, a drum brake, or a coaster brake.

14. The tandem bicycle device of claim 12 further comprised of a control that actuates the braking system.

15. The tandem bicycle device of claim 9, wherein the first seat and the second seat are comprised of a touring saddle, a racing saddle, a suspension saddle, a cruiser-style saddle, an anatomical gel-padded saddle, or a modular saddle.

16. The tandem bicycle device of claim 9, wherein the first seat attaches to the frame via a first seat post.

17. The tandem bicycle device of claim 16, wherein the first seat post is comprised of a first locking mechanism.

18. The tandem bicycle device of claim 9, wherein the second seat attaches to the frame via a second seat post.

19. The tandem bicycle device of claim 18, wherein the second seat post is comprised of a second locking mechanism.

20. A method of using a tandem bicycle device, the method comprising the following steps:
providing a tandem bicycle device comprised of a frame, a first seat, a second seat longitudinally positioned behind the first seat, a first handlebar set, a second handlebar set attached to the frame via a pivot point, a front crankset, a rear crankset, a synchronization mechanism interconnecting the front crankset and the rear crankset, and a braking system;
positioning a front cyclist on the first seat and a rear cyclist on the second seat;
rotating the second handlebar set into a forward position around the front cyclist via the pivot point; and
initiating a coordinated pedaling motion through the front crankset and the rear crankset.
